(19) United States
(12) Patent Application Publication
(10) Pub. No.: US 2025/0363366 A1
(43) Pub. Date: Nov. 27, 2025

(54) STRUCTURE-SECRET NEURAL NETWORK MODEL GENERATION APPARATUS

(71) Applicant: NEC Corporation, Tokyo (JP)

(72) Inventors: Yuki KOBAYASHI, Tokyo (JP); Darshit VAGHANI, Tokyo (JP); Kazutoshi HIROSE, Tokyo (JP)

(73) Assignee: NEC Corporation, Tokyo (JP)

(21) Appl. No.: 19/201,012

(22) Filed: May 7, 2025

(30) Foreign Application Priority Data
May 22, 2024 (JP) 2024-083047

(51) Int. Cl. G06N 3/082

(52) U.S. Cl. CPC G06N 3/082

(57) ABSTRACT

The subnet generation unit generates architecture information, which is information that identifies one candidate structure for each block, and subnet information determined by the architecture information, based on architecture parameters in trained supernet information. The subnet additionally training unit generate additionally trained subnet information by updating parameters in subnet information, by training using a training data set. The structure-secret model information generator generates structure secret model information by replacing parameters of a part that corresponds to the subnet information among parameters included in the trained supernet information with parameters included in the additionally trained subnet information after excluding the predetermined module and the architecture parameters from the trained supernet information.

### CROSS-REFERENCE TO RELATED APPLICATION

This application is based upon and claims the benefit of priority from the prior Japanese Patent Application No. 2024-083047, filed May 22, 2024, the entire contents of which are incorporated herein by reference.

### BACKGROUND OF THE INVENTION

### Technical Field

This disclosure relates to a structure-secret neural network model generation apparatus, a structure-secret neural network model generation method, and a structure-secret neural network model generation program.

### Description of the Related Art

Non-Patent Literature 1 discloses a method of searching for neural network structures using an once-for-all network includes multiple candidate structures.

Non-Patent Literature 2 discloses a method for efficiently searching for neural network structures by setting appropriate initial weights for a supernet including multiple candidate structures.

### Citation List

### Non-Patent Literature

[Non-Patent Literature 1] Han Cai, et al, “ONCE-FOR-ALL: TRAIN ONE NETWORK AND SPECIALIZE IT FOR EFFICIENT DEPLOYMENT”, [online], [retrieved Apr. 15, 2024] [[Non-Patent Literature 29 Jiemin Fang, et al, “FAST NEURAL NETWORK ADAPTATION VIA PARAMETER REMAPPING AND ARCHITECTURE SEARCH”, [online], [retrieved Apr. 15, 2024]

### SUMMARY OF THE INVENTION

Determining a neural network structure is important to achieve a neural network that can run at high speed while maintaining high recognition accuracy.

In general, skilled researchers have been improving neural network structures. In recent years, research on NAS (Neural Architecture Search), which searches for the optimal neural network structure, has progressed, and a method has been proposed to automatically search for a neural network structure with superior recognition accuracy and execution speed for input training data.

In addition, a relatively efficient method of searching for neural network structures, called one-shot NAS, has been proposed in recent years.

However, even if neural network structures can be searched automatically and relatively efficiently, the searching still requires a certain amount of time and cost. For example, according to Non-Patent Literature 2, the cost of running one GPU (Graphics Processing Unit) for 21.6 consecutive days is required to search for neural network structures.

The quality of the search results (searched neural network structures) is also affected by the quality of the training data used during the search. In general, training data is a mass of know-how collected and selected over a long period of time by engineers skilled in a particular application field, and can be a source of competitive advantage. Therefore, the neural network structure resulting from the search must be kept secret so that it cannot be easily used by a third party.

For example, even if the neural network structure resulting from the search is incorporated into a product and deployed in the field, if the neural network structure is stolen and appropriated by a third party, it will weaken competitiveness and cause business damage.

In general, encryption is considered as a method to keep information secret. That is, by encrypting the neural network structure, storing it in a storage area (flash memory, etc.) within the on-site device, and storing the decryption key in a secure area within that device, the risk of the neural network structure being stolen is reduced.

However, when using that neural network structure with that device, it is generally necessary to decrypt the encrypted neural network structure in the storage area and temporarily store it in the external memory. At this time, for example, if the device is infected with malware that steals information, the decrypted neural network structure deployed on the external memory may be stolen. Another known attack method (for example, cold boot attack) is to rapidly cool the external memory with liquid nitrogen or the like while the decrypted data is deployed on an external memory, physically steal the external memory, and read the data with a different device.

The reason for storing the neural network structure after decoding in an external memory is that the capacity of the neural network structure is very large and cannot fit in the internal memory. For example, the capacity of a neural network structure is tens to hundreds of megabytes, which is very large. Therefore, it is difficult to store neural network structures in an internal memory of a computing device such as a register file or a cache memory of a CPU (Central Processing Unit) or GPU.

Therefore, the purpose of this disclosure is to provide a structure-secret neural network model generation apparatus, a structure-secret neural network model generation method, and a structure-secret neural network model generation program, which can keep the generated neural network structure secret.

The structure-secret neural network model generation apparatus according to the present disclosure includes supernet model generation means for generating supernet information based on candidate structure information given as input, supernet training means for generating trained supernet information by updating parameters of modules other than a predetermined module in the supernet information and architecture parameters which are a set of all the parameters of the predetermined module, by training using training data set provided as input, subnet generation means for generating architecture information, which is information that identifies one candidate structure for each block, and subnet information determined by the architecture information, based on the architecture parameters in the trained supernet information, and outputting the architecture information, subnet additionally training means for generating additionally trained subnet information by updating parameters in the subnet information, by training using the training data set, and structure-secret model information generation means for generating structure secret model information by replacing parameters of a part that corresponds to the subnet information among parameters included in the trained supernet information with parameters included in the additionally trained subnet information after excluding the predetermined module and the architecture parameters from the trained supernet information, and outputting the structure secret model information.

The structure-secret neural network model generation apparatus according to the present disclosure includes supernet model generation means for generating supernet information based on candidate structure information given as input, supernet training means for generating trained supernet information by updating parameters of modules other than a predetermined module in the supernet information and architecture parameters which are a set of all the parameters of the predetermined module, by training using training data set provided as input, and output means for outputting information that the predetermined module and the architecture parameters from the trained supernet information, and the architecture parameters, separately.

The computer-implemented structure-secret neural network model generation method according to the present disclosure includes generating supernet information based on candidate structure information given as input, generating trained supernet information by updating parameters of modules other than a predetermined module in the supernet information and architecture parameters which are a set of all the parameters of the predetermined module, by training using training data set provided as input, generating architecture information, which is information that identifies one candidate structure for each block, and subnet information determined by the architecture information, based on the architecture parameters in the trained supernet information, and outputting the architecture information, generating additionally trained subnet information by updating parameters in the subnet information, by training using the training data set, and generating structure secret model information by replacing parameters of a part that corresponds to the subnet information among parameters included in the trained supernet information with parameters included in the additionally trained subnet information after excluding the predetermined module and the architecture parameters from the trained supernet information, and outputting the structure secret model information.

The computer-implemented structure-secret neural network model generation method according to the present disclosure includes generating supernet information based on candidate structure information given as input, generating trained supernet information by updating parameters of modules other than a predetermined module in the supernet information and architecture parameters which are a set of all the parameters of the predetermined module, by training using training data set provided as input, and outputting information that the predetermined module and the architecture parameters from the trained supernet information, and the architecture parameters, separately.

The structure-secret neural network model generation program according to the present disclosure causes a computer to execute a supernet model generation process for generating supernet information based on candidate structure information given as input, a supernet training process for generating trained supernet information by updating parameters of modules other than a predetermined module in the supernet information and architecture parameters which are a set of all the parameters of the predetermined module, by training using training data set provided as input, a subnet generation process for generating architecture information, which is information that identifies one candidate structure for each block, and subnet information determined by the architecture information, based on the architecture parameters in the trained supernet information, and outputting the architecture information, a subnet additionally training process for generating additionally trained subnet information by updating parameters in the subnet information, by training using the training data set, and a structure-secret model information generation process for generating structure secret model information by replacing parameters of a part that corresponds to the subnet information among parameters included in the trained supernet information with parameters included in the additionally trained subnet information after excluding the predetermined module and the architecture parameters from the trained supernet information, and outputting the structure secret model information.

The structure-secret neural network model generation program according to the present causes a computer to execute a supernet model generation process for generating supernet information based on candidate structure information given as input, a supernet training process for generating trained supernet information by updating parameters of modules other than a predetermined module in the supernet information and architecture parameters which are a set of all the parameters of the predetermined module, by training using training data set provided as input, and an output process for outputting information that the predetermined module and the architecture parameters from the trained supernet information, and the architecture parameters, separately.

According to this disclosure, the generated neural network structure can be kept secret.

### BRIEF DESCRIPTION OF THE DRAWINGS

FIG. 1: It depicts a block diagram showing a device that uses information generated by the structure-secret neural network model generation apparatus of the present disclosure.

FIG. 2: It depicts a block diagram showing an example configuration of a structure-secret neural network model generation apparatus of the present disclosure.

FIG. 3: It depicts a schematic diagram showing an example of candidate structure information.

FIG. 4: It depicts a schematic diagram showing an example of supernet information.

FIG. 5: It depicts a schematic diagram showing an example of the structure of the SEL module.

FIG. 6: It depicts a schematic diagram showing architecture parameters and architecture information.

FIG. 7: It depicts a schematic diagram showing an example of subnet information.

FIG. 8: It depicts a schematic diagram showing an example of structure secret model information.

FIG. 9: It depicts a flowchart showing an example of the processing flow of the structure-secret neural network model generation apparatus of the present disclosure.

FIG. 10: It depicts a block diagram showing an example configuration of the structure-secret neural network model generation apparatus of the present disclosure.

FIG. 11: It depicts a schematic block diagram showing an example of a computer configuration for the structure-secret neural network model generation apparatus of the present disclosure.

FIG. 12: It depicts a block diagram showing an overview of the structure-secret neural network model generation apparatus of the present disclosure.

### DESCRIPTION OF THE PREFERRED EMBODIMENTS

Hereinafter, an example embodiment of the present disclosure will be explained with reference to the drawings.

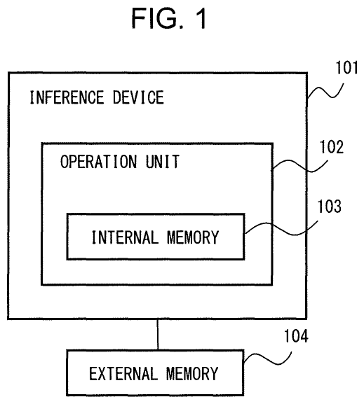

FIG. 1 is a block diagram showing a device (hereinafter referred to as an inference device) that uses information generated by the structure-secret neural network model generation apparatus of the present disclosure. The inference device 101 comprises an operation unit 102. The operation unit 102 includes an internal memory 103. The operation unit 102 is a CPU or GPU, for example. The internal memory 103 is a register file, a cache memory, or the like. It is difficult to steal information stored in the internal memory 103. The inference device 101 is also provided with an external memory 104. As the external memory 104, an off-chip memory separate from the operation unit 102 is assumed.

In this example embodiment, the additionally trained subnet information 70 described below corresponds to the neural network structure.

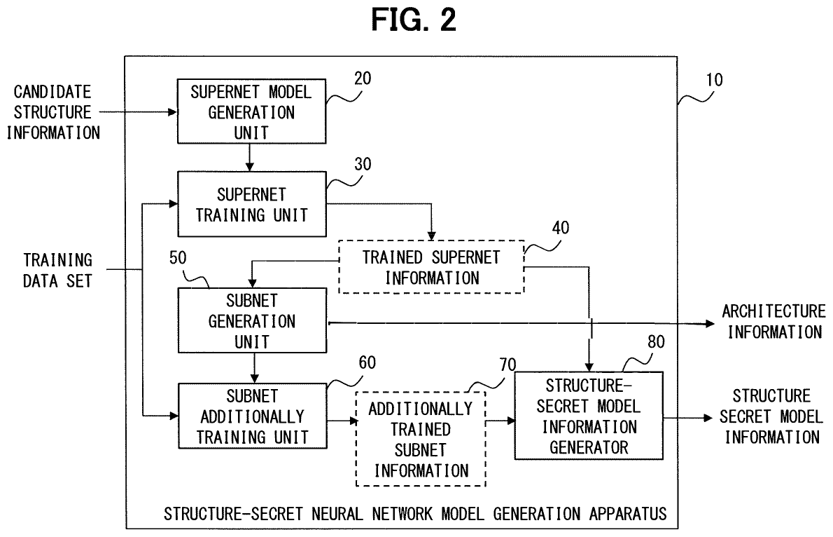

FIG. 2 is a block diagram showing an example configuration of a structure-secret neural network model generation apparatus of the present disclosure. The structure-secret neural network model generation apparatus 10 comprises a supernet model generation unit 20, a supernet training unit 30, a subnet generation unit 50, a subnet additionally training unit 60, and a structure-secret model information generator 80.

The candidate structure information and the training data set are input to the structure-secret neural network model generation apparatus 10.

The supernet model generation unit 20 receives input candidate structure information and generates supernet information before training based on the candidate structure information. The supernet information before training is input to the supernet training unit 30.

Here are the definitions of candidate structures and candidate structure information. “Candidate structure” is a structure that is a candidate for each block in a neural network structure. “Candidate structure information” is information that includes multiple candidate structures for each block.

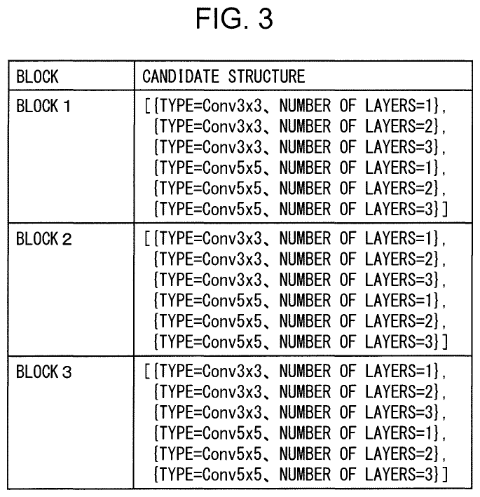

FIG. 3 is a schematic diagram showing an example of candidate structure information. FIG. 3 shows the candidate structure in each block of a neural network structure consisting of three blocks. Here, “block” refers to a rough block of the neural network structure. For example, in a neural network structure used for image recognition, object detection, etc., it is common to proceed with processing while gradually decreasing the spatial resolution, and it is sufficient to treat the portion of processing at the same spatial resolution as a single block.

In the example shown in FIG. 3, for example, the first candidate structure for block 1 is “{type=Conv 3×3}, number of layers=1”. This structure represents a structure that executes only one layer that performs a convolutional operation with a kernel size of 3×3.

For example, the second candidate structure for block 1 is “{type=Conv 3×3}, number of layers=2”. This structure represents a structure that performs two layers performing a convolutional operation with a kernel size of 3×3.

For example, the fourth candidate structure for block 1 is “{type=Conv 5×5}, number of layers=1”. This structure represents a structure that executes only one layer that performs a convolutional operation with a kernel size of 5×5.

The candidate structure need not be the same for each block, and the type of candidate structure may be different for each block. The number of blocks may be other than 3. In addition, the type may include Bottleneck structure, Skip connection, etc., in addition to Conv 3×3, Conv 5×5, etc. In addition, there may be candidate structures with more than 4 layers. In addition to a type and the number of layers, the candidate structure may include other parameters such as number of channels and Expansion Ratio of Inverted Residual Block. For example, let the type be Conv 3×3, Conv 5×5, and Conv 7×7, and the number of layers be 1-8. Then, when the number of candidate structures per block is K, K=3*8=24.

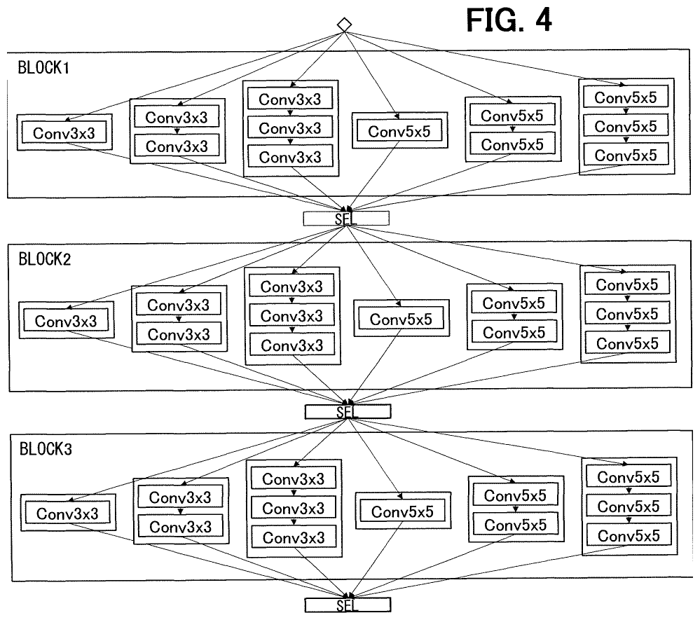

FIG. 4 is a schematic diagram showing an example of supernet information. The “supernet information” is information indicating the neural network structure that encompasses all neural network structures included in the search space of the neural network structure search. As mentioned above, the supernet model generation unit 20 generates the supernet information before training based on the candidate structure information. The supernet information also includes SEL modules, as shown in FIG. 4. For the sake of clarity, the supernet information is illustrated graphically in FIG. 4, but the supernet information may be represented in other ways. FIG. 4 shows that each block 1-3 includes 6 candidate structures each. The SEL module is a module that combines the outputs of the candidate structures in each block. The SEL module can be referred to as a predetermined module. In addition, modules such as Conv 3×3 and Conv 5×5 include trainable parameters. These trainable parameters are weights, biases, etc. The weights and biases are the weights and biases in the convolution operation. The supernet model generation unit 20 sets initial values of the parameters for each module (in this example, Conv 3×3, Conv 5×5) other than the SEL module to initial values obtained by He initialization, for example.

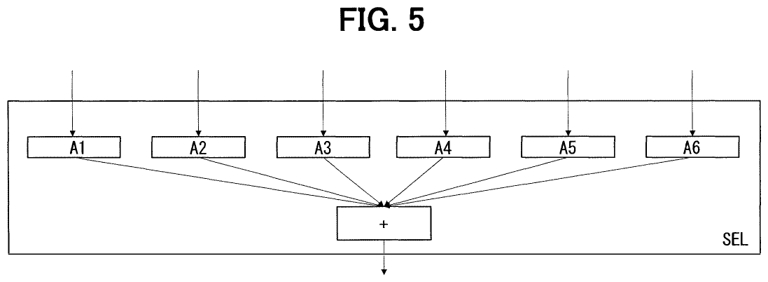

FIG. 5 is a schematic diagram showing an example of the structure of the SEL module. In the SEL module illustrated in FIG. 4, there are six inputs and one output. The SEL module multiplies each of the six inputs by a factor A1 to A6, adds the results of the multiplication, and outputs the result of the addition.

The coefficients A1 through A6 of the SEL module are trainable parameters. For each SEL module, the supernet model generation unit 20 sets the initial value of each coefficient A to an equal value that sums to 1. In the example shown in FIG. 4, the number of coefficients A in any SEL module is 6, since there are 6 candidate structures in each individual block. Therefore, in this example, the s supernet model generation unit 20 sets the initial values of the coefficients A1to A6 to 0.16 in each SEL module, respectively.

In the supernet information before training, each parameter is set to the initial value.

The supernet training unit 30 receives input training data set and also receives supernet information before training input from the supernet model generation unit 20. The set of all parameters A of the SEL module in the supernet information is called an architecture parameter. The supernet training unit 30 generates the trained supernet information 40 by updating the parameters (weights and biases) of modules other than the SEL modules in the supernet information and the architecture parameter (the set of all parameters A of the SEL modules), by training using training data set as teacher data. The “trained supernet information 40” is supernet information after each parameter has been updated by training using the training data set.

As described above, the supernet training unit 30 updates the parameters (weights and biases) of modules other than the SEL modules and architecture parameters (the set of all parameters A of the SEL modules) in the supernet information by training using the training data set as teacher data. Therefore, in the example shown in FIG. 4, the parameters (weights and biases) of individual Conv 3×3 and Conv 5×5 and the parameters A of individual SEL modules are updated by the training process.

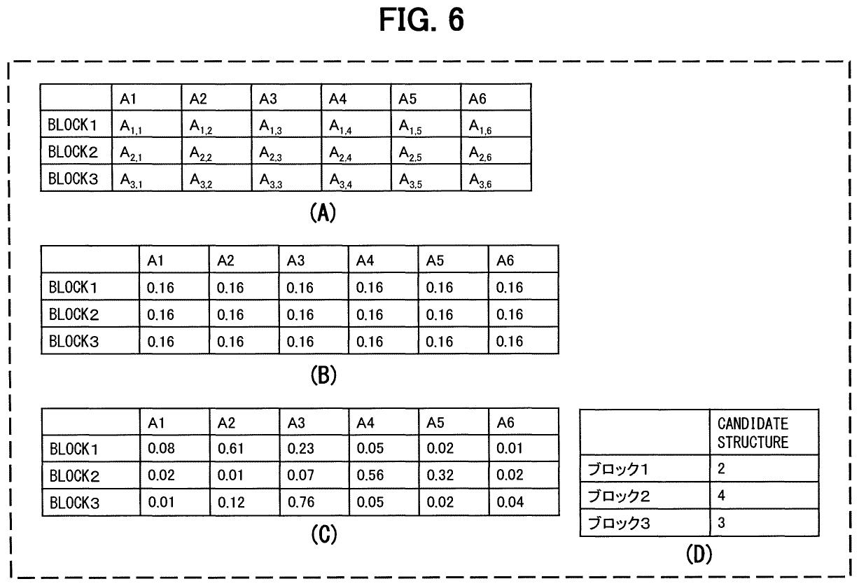

As mentioned above, the pair of all parameters A of the SEL module in the supernet information is called the architecture parameter. FIG. 6 is a schematic diagram showing architecture parameters and architecture information. The architecture information is described below. In the example shown in FIG. 4, there are six coefficients A in each of the three SEL modules. Therefore, in this example, as shown in (A) of FIG. 6, the architecture parameter is a set of 6*3=18 numbers A_{b, c}. Here, the subscript b represents the index of the block, and the subscript c represents the index of the candidate structure.

In (B) of FIG. 6, the initial values of the architecture parameters are shown. In individual blocks, the sum of all A is approximately 1.

In (C) of FIG. 6, an example of the architecture parameters after training is shown. In individual blocks, the sum of all A is 1.

The subnet generation unit 50 receives the trained supernet information 40 generated by the supernet training unit 30. Then, the subnet generation unit 50 generates architecture information, which is information that identifies one candidate structure for each block, and subnet information determined by the architecture information, based on the architecture parameters in the trained supernet information 40. As described above, the “architecture information” is information that identifies one candidate structure per block. The “subnet information” is information that indicates a neural network structure represented by the candidate structure selected for each block. In each block, the candidate structure corresponding to the largest A is selected. The “Architecture Information” identifies the candidate structure corresponding to the largest A for each block. Therefore, the “architecture information” determines the “subnet information”.

The subnet generation unit 50 outputs the generated architecture information externally. This architecture information is stored in the internal memory 103 (see FIG. 1) of the inference device 101. The subnet generation unit 50 may output the architecture information directly to the internal memory 103 of the inference device 101.

When generating the architecture information and the subnet information, the subnet generation unit 50 selects the candidate structure corresponding to the largest A_{b, c} in each block. For example, suppose that the architecture parameters shown in (C) of FIG. 6 are obtained in the trained supernet information 40. In this case, the subnet generation unit 50 selects the second candidate structure in block 1. The subnet generation unit 50 also selects the fourth candidate structure in block 2. The subnet generation unit 50 selects the third candidate structure in block 3. Then, the subnet generation unit 50 generates architecture information and subnet information indicating the neural network structure composed of the selected candidate structures.

(D) of FIG. 6 shows an example of the architecture information generated in this example. As shown in (D) of FIG. 6, the architecture information includes an index of the selected candidate structure for each block. As a result, the architecture information identifies one candidate structure per block.

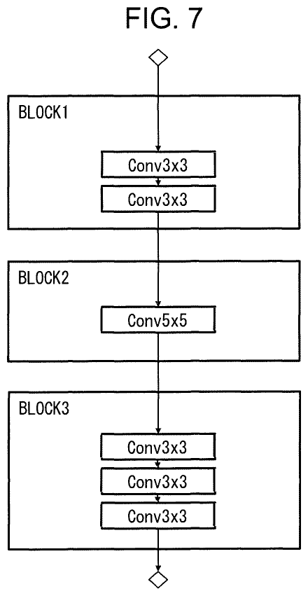

FIG. 7 is a schematic diagram showing an example of the subnet information generated in this example. As can be seen from FIG. 7, in the subnet information, the candidate structure identified by the architecture information is selected for each block. In addition, the subnet information does not include SEL modules. This is because in the subnet information, only one candidate structure is selected for each block, and there is no need to combine the outputs of multiple candidate structures. The subnet information also does not include architecture parameters or architecture information.

The subnet additionally training unit 60 receives the input training data set and also receives the subnet information generated by the subnet generation unit 50. The subnet additionally training unit 60 generates the additionally trained subnet information 70 by updating the parameters in the subnet information by training using the training data set as the teacher data. More specifically, the subnet additionally training unit 60 generates the additionally trained subnet information 70 by updating the parameters (weights and biases) of each module in the subnet information by training using the training data set as the teacher data. The “additionally trained subnet information 70” is subnet information for which the parameters in the subnet information have been updated by training after the subnet information has been generated.

The structure-secret model information generator 80 receives the trained supernet information 40 generated by the supernet training unit 30 and the additionally trained subnet information 70 generated by the subnet additionally training unit 60. The structure-secret model information generator 80 generates the structure secret model information using the trained supernet information 40 and the additionally trained subnet information 70.

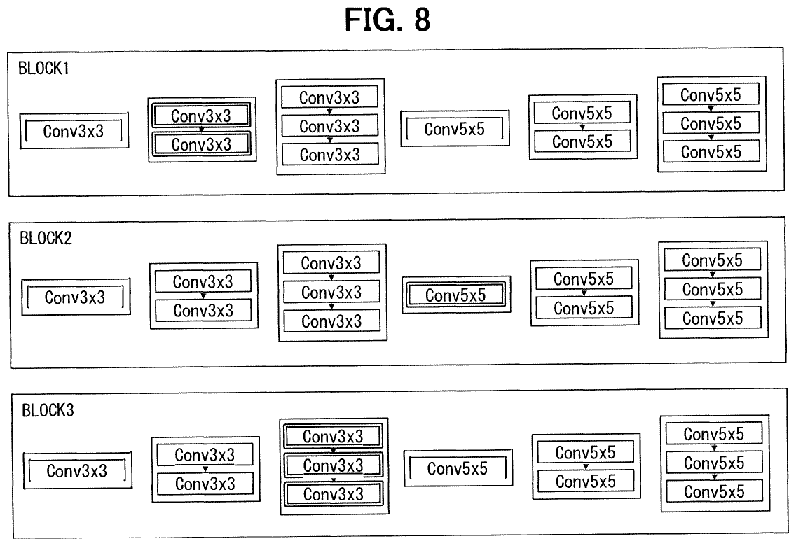

FIG. 8 is a schematic diagram showing an example of the structure secret model information. The structure secret model information is obtained by excluding the SEL module and architecture parameters from the trained supernet information 40 and replacing the parameters of the part (module) that corresponds to the subnet information among the parameters included in the trained supernet information 40 with the parameters included in the additionally trained subnet information 70. In FIG. 8, the module whose parameters have been replaced is highlighted with double lines.

Therefore, the structure-secret model information generator 80 generates the structure secret model information by excluding the SEL module and architecture parameters from the trained supernet information 40, and replacing the parameters of the part (module) that corresponds to the subnet information among the parameters included in the trained supernet information with the parameters included in the additionally trained subnet information 70.

In the structure secret model information, the parameters (weights and biases) of the part (module) that does not correspond to the subnet information (see FIG. 7) are the parameters included in the trained supernet information 40. However, the parameters of the part of the structure secret model information that does not correspond to the subnet information may be parameters included in the supernet information before training or random values.

The structure-secret model information generator 80 outputs the generated structure secret model information externally. This structure secret model information is stored in the external memory 104 (see FIG. 1) provided in the inference device 101. The structure-secret model information generator 80 may output the structure secret model information directly to the external memory 104.

The structure secret model information does not include the SEL module and architecture parameters, as well as the architecture information. Since the architecture information is stored in internal memory 103, it is difficult for a third party to steal the architecture information. Therefore, even if a third party obtains only the structure secret model information stored in external memory 104, it is difficult to retrieve the additionally trained subnet information 70.

Consider the case where a third party retrieves additionally trained subnet information 70 from the structure secret model information without architecture information. Let B be the number of blocks, and K be the average number of candidate structures per block. In this case, there are K^{B} possible combinations of subnet information. In order for a third party to obtain the additionally trained subnet information 70 without architecture information, it is necessary to perform inference processing on all K^{B} subnet information using evaluation data set to obtain the subnet information with the best inference accuracy, which is extremely time consuming. For example, consider the case of an evaluation using an evaluation data set consisting of 1000 images, using hardware capable of performing inference on 100 images per second. Here, for example, when K=24 and B=4, K^{B}=331776 combinations need to be evaluated, and this evaluation requires 3317760 seconds, i.e., about 40 days. In practice, the values of K and B are expected to be much larger, making it extremely difficult for a third party to retrieve the additionally trained subnet information 70.

Therefore, the generated neural network structure (additionally trained subnet information 70) can be kept secret.

The capacity of the structure secret model information is larger than the capacity of the additionally trained subnet information 70, but is at most K times larger than the additionally trained subnet information 70.

When the inference device 101 is used by an authorized user of the inference device 101 (see FIG. 1) rather than a third party, the operation unit 102 can easily retrieve the parameters corresponding to the additionally trained subnet information 70 from the structure secret model information by referring to the architecture information stored in the internal memory 103, and inference process can then be executed. At this time, the operation unit 102 extracts not only the parameters corresponding to the additionally trained subnet information 70 but also unnecessary parameters, making it difficult for a third party to identify the additionally trained subnet information 70 even if bus communication between memories is intercepted.

The supernet model generation unit 20, the supernet training unit 30, the subnet generation unit 50, the subnet additionally training unit 60, and the structure-secret model information generator 80 are realized, for example, by a CPU of a computer operating according to a structure-secret neural network model generation program. The CPU reads the structure-secret neural network model generation program from a program storage medium, such as a program storage device of a computer, and operates the supernet model generation unit 20, the supernet training unit 30, the subnet generation unit 50, the subnet additionally training unit 60, and the structure-secret model information generator 80 according to the structure-secret neural network model generation program. The CPU may operate as the supernet model generation unit 20, the supernet training unit 30, the subnet generation unit 50, the subnet additionally training unit 60, and structure-secret model information generator 80 according to the structure-secret neural network model generation program.

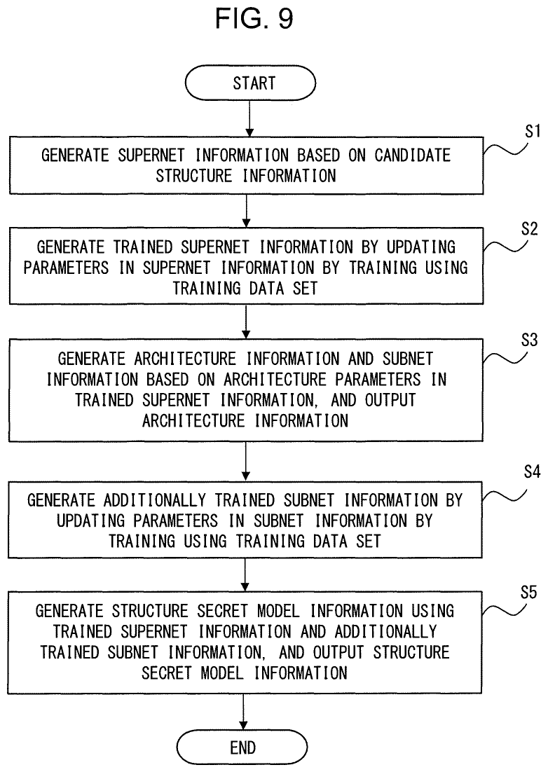

Next, the processing flow will be described. FIG. 9 is a flowchart showing an example of the processing flow of the structure-secret neural network model generation apparatus of the present disclosure. Detailed explanations of matters already explained are omitted.

First, the supernet model generation unit 20 generates supernet information based on the candidate structure information (step S1). In step S1, the supernet model generation unit 20 defines initial values of the parameters (parameters of modules other than the SEL module and architecture parameters) included in the supernet information.

Next, the supernet training unit 30 generates the trained supernet information 40 by updating the parameters in the supernet information (parameters of modules other than the SEL module and architecture parameters) by training using the training data set (step S2).

Next, the subnet generation unit 50 generates the architecture information and the subnet information based on the architecture parameters in the trained supernet information 40. The subnet generation unit 50 outputs the architecture information (step S3). The output architecture information is stored in the internal memory 103 (see FIG. 1) of the inference device 101.

Next, the subnet additionally training unit 60 generates additionally trained subnet information 70 by updating the parameters in the subnet information by training using the training data set (step S4).

Next, the structure-secret model information generator 80 generates the structure secret model information using the trained supernet information 40 and the additionally trained subnet information 70. Specifically, the structure-secret model information generator 80 replaces the parameters in the trained supernet information 40 that correspond to the subnet information with the parameters included in the additionally trained subnet information 70 after excluding the SEL module and architecture parameters from the trained supernet information 40. The structure-secret model information generator 80 outputs the structure secret model information (step S5). The output structure secret model information is stored in the external memory 104 provided in the inference device 101.

It is difficult to steal architecture information stored in internal memory 103. In addition, as mentioned above, even if a third party could obtain the structure secret model information from the external memory 104, it would be difficult to obtain the additionally trained subnet information 70 without the architecture information. Therefore, the generated neural network structure (additionally trained subnet information 70) can be kept secret.

Even in the case of training a normal neural network without using supernet information, the neural network structure can be kept secret in the same way as in this example embodiment by generating information equivalent to the structure secret model information and the architecture information in a pseudo manner.

In the above example embodiment, the subnet generation unit 50 generates the architecture information and the subnet information by selecting the candidate structure corresponding to the largest coefficient A_{b, c} in each block. The subnet generation unit 50 may generate the second architecture information and the second subnet information by selecting the candidate structure corresponding to the second largest coefficient A_{b, c} as well as the candidate structure corresponding to the largest coefficient A_{b, c} in each block. In this case, the first and second architecture information is stored in the internal memory 103 of the inference device 101.

Further, in this case, the subnet additionally training unit 60 trains additionally trained subnet information corresponding to the first subnet information (hereinafter referred to as the first additionally trained subnet information) and additionally trained subnet information corresponding to the second subnet information (hereinafter referred to as the second additionally trained subnet information) by training using the training data set. In addition to the operations described above, the structure-secret model information generator 80 replaces the parameters in the trained supernet information that correspond to the second subnet information with the parameters in the second additionally trained subnet information. As a result, the structure secret model information includes the parameters of the first additionally trained subnet information and the parameters of the second additionally trained subnet information. This structure secret model information is stored in the external memory 104.

As a result, by switching the architecture information provided according to the user, the additionally trained subnet information available to the user can be switched. For example, the first architecture information can be provided and the first additionally trained subnet information made available to users who have paid a higher than usual license fee, and the second architecture information can be provided and the second additionally trained subnet information made available to users who have paid a normal license fee. In this case, the first additionally trained subnet information and the second additionally trained subnet information can also be kept secret.

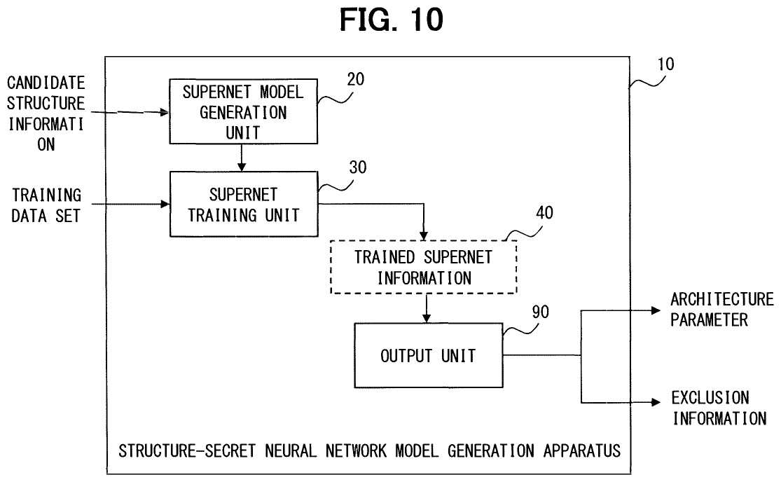

Next, a modification of the above example embodiment is shown. FIG. 10 is a block diagram showing an example configuration of a structure-secret neural network model generation apparatus of the present disclosure. In the modification, the structure-secret neural network model generation apparatus 10 comprises a supernet model generation unit 20, a supernet training unit 30, and an output unit 90.

The supernet model generation unit 20 and the supernet training unit 30 are the same as the supernet model generation unit 20 and the supernet training unit 30 (see FIG. 2) in the above example embodiment, and are not described here.

The output unit 90 receives the trained supernet information 40 generated by the supernet training unit 30. The output unit 90 then extracts architecture parameters (for example, see (C) of FIG. 6) from the trained supernet information 40. Further, the output unit 90 generates information (hereinafter referred to as “exclusion information”) excluding the SEL module and architecture parameters from the trained supernet information 40. The output unit 90 generates the information that excludes the SEL module and architecture parameters from the trained supernet information 40. Then, the output unit 90 outputs the architecture parameters and the exclusion information separately. The output architecture parameters are stored in the internal memory 103 of the inference device 101. The output exclusion information is stored in the external memory 104 provided in the inference device 101. The output unit 90 may output the architecture parameters directly to the internal memory 103 of the inference device 101 and the exclusion information directly to the external memory 104.

The supernet model generation unit 20, the supernet training unit 30, and the output unit 90 are realized, for example, by a CPU of a computer operating in accordance with a structure-secret neural network model generation program. The CPU can read the structure-secret neural network model generation program from a program storage medium such as a program storage device of the computer, and operate as the supernet model generation unit 20, the supernet training unit 30, and the output unit 90 according to the structure-secret neural network model generation program.

The largest coefficient A_{b,c} for each block is acknowledged by the architecture parameter. Therefore, the subnet information can be identified by the largest coefficient A_{b, c} for each block and the exclusion information, and the subnet information can be kept secret. In this modification, no additionally trained subnet information is generated, but as described above, the subnet information can be identified and the subnet information can be kept secret.

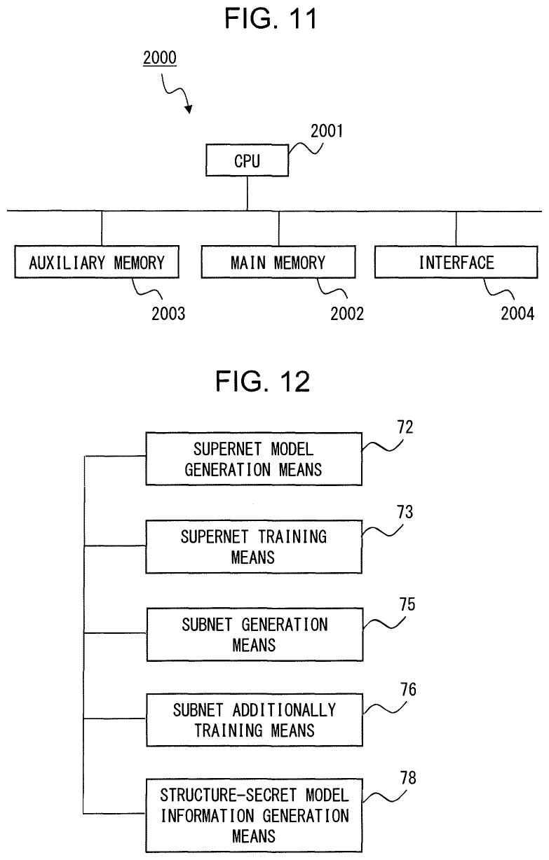

FIG. 11 is a schematic block diagram showing an example configuration of a computer for the structure-secret neural network model generation apparatus of the present disclosure. The computer 2000, for example, has a CPU 2001, a main memory 2002, an auxiliary memory 2003, and an interface 2004.

The structure-secret neural network model generation apparatus 10 of the example embodiment and its modification in the present disclosure is realized by the computer 2000, for example. The operation of the structure-secret neural network model generation apparatus 10 is stored in the auxiliary memory 2003 in the form of a program (structure-secret neural network model generation program). The CPU 2001 reads the program from the auxiliary memory 2003, deploys the program in the main memory 2002, and executes the processes described in the above example embodiments and the modification according to the program.

The auxiliary memory 2003 is an example of a non-transitory tangible medium. Other examples of non-transitory tangible media include magnetic disks, optical disks, CD-ROM (Compact Disk Read Only Memory), DVD-ROM (Digital Versatile Disk Read Only Memory), semiconductor memory, etc., connected through interface 2004.

Next, an overview of the structure-secret neural network model generation apparatus of this disclosure will be described. FIG. 12 is a block diagram showing an overview of the structure- secret neural network model generation apparatus of the present disclosure. The structure-secret neural network model generation apparatus comprises supernet model generation means 72, supernet training means 73, subnet generation means 75, subnet additionally training means, and structure-secret model information generation means 78.

The supernet model generation means 72 (for example, the supernet model generation unit 20) generates supernet information based on candidate structure information given as input.

The upernet training means 73 (for example, the supernet training unit 30) generates trained supernet information by updating parameters of modules other than a predetermined module (for example, the SEL module) in the supernet information and architecture parameters which are a set of all the parameters of the predetermined module, by training using training data set provided as input.

The subnet generation means 75 (for example, the subnet generation unit 50) generates architecture information, which is information that identifies one candidate structure for each block, and subnet information determined by the architecture information, based on the architecture parameters in the trained supernet information, and outputs the architecture information.

The subnet additionally training means 76 (for example, the subnet additionally training unit 60) generates additionally trained subnet information by updating parameters in the subnet information, by training using the training data set.

The structure-secret model information generation means 78 (for example, the structure-secret model information generator 80) generates structure secret model information by replacing parameters of a part that corresponds to the subnet information among parameters included in the trained supernet information with parameters included in the additionally trained subnet information after excluding the predetermined module and the architecture parameters from the trained supernet information, and outputs the structure secret model information.

Such a configuration allows the generated neural network structure to be kept secret.

A part of or all of the above example embodiments may also be described as, but not limited to, the following supplementary notes.

### (Supplementary Note 1)

A structure-secret neural network model generation apparatus comprising:
supernet model generation means for generating supernet information based on candidate structure information given as input,
supernet training means for generating trained supernet information by updating parameters of modules other than a predetermined module in the supernet information and architecture parameters which are a set of all the parameters of the predetermined module, by training using training data set provided as input,
subnet generation means for generating architecture information, which is information that identifies one candidate structure for each block, and subnet information determined by the architecture information, based on the architecture parameters in the trained supernet information, and outputting the architecture information,
subnet additionally training means for generating additionally trained subnet information by updating parameters in the subnet information, by training using the training data set, and
structure-secret model information generation means for generating structure secret model information by replacing parameters of a part that corresponds to the subnet information among parameters included in the trained supernet information with parameters included in the additionally trained subnet information after excluding the predetermined module and the architecture parameters from the trained supernet information, and outputting the structure secret model information.

### (Supplementary Note 2)

The structure-secret neural network model generation apparatus according to Supplementary note 1, wherein the parameters of modules other than the predetermined module include weights and biases in a convolution operation.

### (Supplementary Note 3)

A structure-secret neural network model generation apparatus comprising:
supernet model generation means for generating supernet information based on candidate structure information given as input,
supernet training means for generating trained supernet information by updating parameters of modules other than a predetermined module in the supernet information and architecture parameters which are a set of all the parameters of the predetermined module, by training using training data set provided as input, and
output means for outputting information that the predetermined module and the architecture parameters from the trained supernet information, and the architecture parameters, separately.

### (Supplementary Note 4)

A computer-implemented structure-secret neural network model generation method comprising:
generating supernet information based on candidate structure information given as input,
generating trained supernet information by updating parameters of modules other than a predetermined module in the supernet information and architecture parameters which are a set of all the parameters of the predetermined module, by training using training data set provided as input,
generating architecture information, which is information that identifies one candidate structure for each block, and subnet information determined by the architecture information, based on the architecture parameters in the trained supernet information, and outputting the architecture information,
generating additionally trained subnet information by updating parameters in the subnet information, by training using the training data set, and
generating structure secret model information by replacing parameters of a part that corresponds to the subnet information among parameters included in the trained supernet information with parameters included in the additionally trained subnet information after excluding the predetermined module and the architecture parameters from the trained supernet information, and outputting the structure secret model information.

### (Supplementary Note 5)

A computer-implemented structure-secret neural network model generation method comprising:
generating supernet information based on candidate structure information given as input,
generating trained supernet information by updating parameters of modules other than a predetermined module in the supernet information and architecture parameters which are a set of all the parameters of the predetermined module, by training using training data set provided as input, and
outputting information that the predetermined module and the architecture parameters from the trained supernet information, and the architecture parameters, separately.

### (Supplementary Note 6)

A structure-secret neural network model generation program for causing a computer to execute:
a supernet model generation process for generating supernet information based on candidate structure information given as input,
a supernet training process for generating trained supernet information by updating parameters of modules other than a predetermined module in the supernet information and architecture parameters which are a set of all the parameters of the predetermined module, by training using training data set provided as input,
a subnet generation process for generating architecture information, which is information that identifies one candidate structure for each block, and subnet information determined by the architecture information, based on the architecture parameters in the trained supernet information, and outputting the architecture information,
a subnet additionally training process for generating additionally trained subnet information by updating parameters in the subnet information, by training using the training data set, and
a structure-secret model information generation process for generating structure secret model information by replacing parameters of a part that corresponds to the subnet information among parameters included in the trained supernet information with parameters included in the additionally trained subnet information after excluding the predetermined module and the architecture parameters from the trained supernet information, and outputting the structure secret model information.

### (Supplementary Note 7)

A structure-secret neural network model generation program for causing a computer to execute:
a supernet model generation process for generating supernet information based on candidate structure information given as input,
a supernet training process for generating trained supernet information by updating parameters of modules other than a predetermined module in the supernet information and architecture parameters which are a set of all the parameters of the predetermined module, by training using training data set provided as input, and
an output process for outputting information that the predetermined module and the architecture parameters from the trained supernet information, and the architecture parameters, separately.

Some or all of the configurations described in Supplementary note 2, which are dependent on Supplementary note 1 described above, can be dependent on Supplementary notes 3 to 7 by the same dependency relationship as Supplementary note 2. Furthermore, not limited to Supplementary notes 3 to 7, some or all of the configurations described as Supplementary notes can similarly depend on various hardware, software, various recording means for recording software, or systems, to the extent not deviating from each example embodiment described above.

Although the present disclosure has been described above with reference to example embodiments, the present disclosure is not limited to the above example embodiments. Various changes can be made to the configuration and details of the present disclosure that can be understood by those skilled in the art within the scope of the present disclosure.

### INDUSTRIAL APPLICABILITY

The present disclosure is suitably applied to the generation of neural network structures.

What is claimed is:

1. A structure-secret neural network model generation apparatus comprising:
a memory storing software instructions, and
one or more processors configured to execute the software instructions to
generate supernet information based on candidate structure information given as input,
generate trained supernet information by updating parameters of modules other than a predetermined module in the supernet information and architecture parameters which are a set of all the parameters of the predetermined module, by training using training data set provided as input,
generate architecture information, which is information that identifies one candidate structure for each block, and subnet information determined by the architecture information, based on the architecture parameters in the trained supernet information, and output the architecture information,
generate additionally trained subnet information by updating parameters in the subnet information, by training using the training data set, and
generate structure secret model information by replacing parameters of a part that corresponds to the subnet information among parameters included in the trained supernet information with parameters included in the additionally trained subnet information after excluding the predetermined module and the architecture parameters from the trained supernet information, and output the structure secret model information.

2. The structure-secret neural network model generation apparatus according to claim 1, wherein the parameters of modules other than the predetermined module include weights and biases in a convolution operation.

3. A structure-secret neural network model generation apparatus comprising:
a memory storing software instructions, and
one or more processors configured to execute the software instructions to
generate supernet information based on candidate structure information given as input,
generate trained supernet information by updating parameters of modules other than a predetermined module in the supernet information and architecture parameters which are a set of all the parameters of the predetermined module, by training using training data set provided as input, and
output information that the predetermined module and the architecture parameters from the trained supernet information, and the architecture parameters, separately.

4. The structure-secret neural network model generation apparatus according to claim 3, wherein the parameters of modules other than the predetermined module include weights and biases in a convolution operation.

5. A computer-implemented structure-secret neural network model generation method comprising:
generating supernet information based on candidate structure information given as input,
generating trained supernet information by updating parameters of modules other than a predetermined module in the supernet information and architecture parameters which are a set of all the parameters of the predetermined module, by training using training data set provided as input,
generating architecture information, which is information that identifies one candidate structure for each block, and subnet information determined by the architecture information, based on the architecture parameters in the trained supernet information, and outputting the architecture information,
generating additionally trained subnet information by updating parameters in the subnet information, by training using the training data set, and
generating structure secret model information by replacing parameters of a part that corresponds to the subnet information among parameters included in the trained supernet information with parameters included in the additionally trained subnet information after excluding the predetermined module and the architecture parameters from the trained supernet information, and outputting the structure secret model information.

6. The computer-implemented structure-secret neural network model generation method according to claim 5, wherein the parameters of modules other than the predetermined module include weights and biases in a convolution operation.
